(19) United States
(12) Patent Application Publication
(10) Pub. No.: US 2025/0200507 A1
(43) Pub. Date: Jun. 19, 2025

(54) METHOD AND COMPUTING DEVICE

(71) Applicant: NICOVENTURES TRADING LIMITED, London (GB)

(72) Inventors: Paul TOLLERFIELD, London (GB); Joseph SUTTON, London (GB); Sally BELL, London (GB)

(21) Appl. No.: 18/846,498

(22) PCT Filed: Mar. 14, 2023
(86) PCT No.: PCT/GB2023/050594

§ 371 Date: Sep. 12, 2024

(30) Foreign Application Priority Data
Mar. 15, 2022 (GB) 2203598.4

(51) Int. Cl. G06Q 10/087; G06Q 30/0601

(52) U.S. Cl. CPC G06Q 10/087; G06Q 30/0635

(57) ABSTRACT

A computer implemented method comprises transmitting a request for stock information to one or more vendors of articles for an aerosol provision system in response to determining that an article for the aerosol provision system needs to be replaced, determining, based on the stock information received from the one or more vendors, one or more orders, wherein each order of the one or more orders comprises a number of articles to be purchased, a unit cost of each article to be purchased, a lead time for delivering the articles to be purchased and a vendor of the one or more vendors, and providing, to a user of the aerosol provision system, a notification including the one or more orders.

### TECHNICAL FIELD

The present invention relates to a computer implemented method and a computing device.

### BACKGROUND

Electronic aerosol provision systems such as electronic cigarettes (e-cigarettes) generally contain an aerosol-generating material, such as a reservoir of a source liquid containing a formulation, typically including nicotine, or a solid material such as a tobacco-based product, from which an aerosol is generated for inhalation by a user, for example through heat vaporisation. Thus, an aerosol provision system will typically comprise an aerosol generator, e.g. a heating element, arranged to aerosolise a portion of aerosol-generating material to generate an aerosol in an aerosol generation region of an air channel through the aerosol provision system. As a user inhales on the device and electrical power is supplied to the aerosol generator, air is drawn into the device through one or more inlet holes and along the air channel to the aerosol generation region, where the air mixes with the vaporised aerosol generator and forms a condensation aerosol. The air drawn through the aerosol generation region continues along the air channel to a mouthpiece, carrying some of the aerosol with it, and out through the mouthpiece for inhalation by the user.

It is common for aerosol provision systems to comprise a modular assembly, often having two main functional parts, namely an aerosol provision device and an article. Typically, the article will comprise the article aerosol-generating material and the aerosol generator (heating element), while the aerosol provision device part will comprise longer-life items, such as a rechargeable battery, device control circuitry and user interface features. The aerosol provision device may also be referred to as a reusable part or battery section and the article may also be referred to as a consumable, disposable/replaceable part, cartridge or cartomiser.

The aerosol provision device and article are mechanically coupled together at an interface for use, for example using a screw thread, bayonet, latched or friction fit fixing. When the aerosol-generating material in an article has been exhausted, or the user wishes to switch to a different article having a different aerosol-generating material, the article may be removed from the aerosol provision device and a replacement article may be attached to the device in its place.

It can be difficult for the user of the aerosol provision system to determine when an article needs to be replaced and acquire a suitable replacement article. For example, the aerosol generating material in the article may be exhausted in the middle of a vaping session and the user located a long distance from a shop or other means of obtaining a replacement article.

Various approaches are described herein which seek to help address or mitigate some of the issues discussed above.

### SUMMARY

The disclosure is defined in the appended claims.

In accordance with some embodiments described herein, there is provided a computer implemented method comprising in response to determining that an article for an aerosol provision system needs to be replaced, transmitting a request for stock information to one or more vendors of articles for the aerosol provision system, determining, based on the stock information received from the one or more vendors, one or more orders, wherein each order of the one or more orders comprises a number of articles to be purchased, a unit cost of each article to be purchased, a lead time for delivering the articles to be purchased and a vendor of the one or more vendors, and providing, to a user of the aerosol provision system, a notification including the one or more orders.

The stock information can comprise one or more of a number of articles in stock that correspond to the article that needs to be replaced, a cost of each article in stock that corresponds to the article that needs to be replaced, and a lead time for delivering the articles in stock that correspond to the article that needs to be replaced.

The stock information further can comprise a location of the vendor, and the one or more orders are determined based on the location of the vendor.

Transmitting the request for stock information to the one or more vendors of articles for the aerosol provision system can include transmitting the request for stock information to the one or more vendors of articles for the aerosol provision system within a certain distance of the aerosol provision system and/or a computing device communicatively coupled to the aerosol provision system.

The request for stock information can include one or more characteristics of the article that is determined to need to be replaced. The characteristics can be at least one of an ingredient or flavourant within the article, a concentration and/or an amount of the ingredient or flavourant, a size of the article, a type of the article, and an identifier of the article. The characteristics can be received from the aerosol provision system.

The method can also comprise determining, in response to the stock information indicating that the article is not in stock at one or more of the vendors, an alternative article based on the received stock information and one or more user preferences, and providing an indication of the alternative article with the notification.

Each order of the one or more orders can comprise an eco-score based on the environmental footprint of the order. The eco-score can be included in the received stock information or the stock information can comprise a location of the vendor, and the eco-score is determined based on the location of the vendor.

The method can further comprise receiving, from the user, a selection of an order of the one or more orders, and sending the order to a vendor of the one or more vendors to furnish the order.

Determining that the article needs to be replaced can be based on an indication received from the aerosol provision system, an indication received from the user, and/or one or more of a time between one or more previously placed orders and the number of articles in a previously placed order.

There is also provided a computer readable storage medium comprising instructions which, when executed by a processor, performs the above method.

In accordance with some embodiments described herein, there is provided a computing device comprising one or more processors, and memory configured to store instruction that, when executed by the one or more processors cause the one or more processors to perform the above method.

These aspects and other aspects will be apparent from the following detailed description. In this regard, particular sections of the description are not to be read in isolation from other sections.

### BRIEF DESCRIPTION OF DRAWINGS

Embodiments of the invention will now be described, by way of example only, with reference to accompanying drawings, in which:

FIG. 1 is a schematic diagram of an aerosol provision system;

FIG. 2 is a schematic diagram of a system comprising an aerosol system;

FIG. 3 is a flow diagram of a method for determining one or more orders.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

The present disclosure relates to aerosol provision systems, which may also be referred to as vapour provision systems, such as e-cigarettes. Throughout the following description the term “e-cigarette” or “electronic cigarette” may sometimes be used, but it will be appreciated this term may be used interchangeably with aerosol provision system and electronic aerosol provision system.

As noted above, aerosol provision systems (e-cigarettes) often comprise a modular assembly including both a reusable part (aerosol provision device) and a replaceable (disposable) or refillable cartridge part, referred to as an article. Systems conforming to this type of two-part modular configuration may generally be referred to as two-part systems or devices. It is also common for electronic cigarettes to have a generally elongate shape. For the sake of providing a concrete example, certain embodiments of the disclosure described herein comprise this kind of generally elongate two-part system employing refillable cartridges. However, it will be appreciated the underlying principles described herein may equally be adopted for other electronic cigarette configurations, for example modular systems comprising more than two parts, as devices conforming to other overall shapes, for example based on so-called box-mod high performance devices that typically have a more boxy shape, or even systems comprising one part where the aerosol provision device and article are integrally formed with one another.

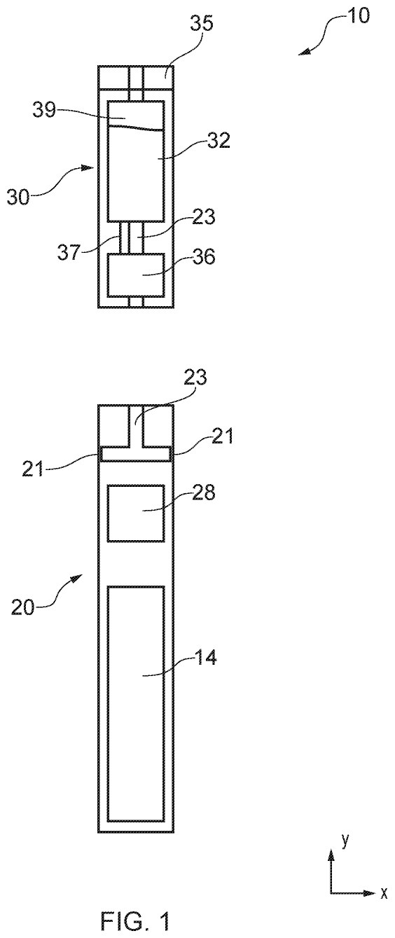

FIG. 1 is a highly schematic diagram (not to scale) of an example aerosol provision system 10, such as an e-cigarette, to which embodiments are applicable. The aerosol provision system 10 has a generally cylindrical shape, extending along a longitudinal or y axis as indicated by the axes (although aspects of the invention are applicable to e-cigarettes configured in other shapes and arrangements), and comprises two main components, namely an aerosol provision device 20 and an article 30.

The article 30 comprises or consists of aerosol-generating material 32, part or all of which is intended to be consumed during use by a user. An article 30 may comprise one or more other components, such as an aerosol-generating material storage area 39, an aerosol-generating material transfer component 37, an aerosol generation area, a housing, a wrapper, a mouthpiece 35, a filter and/or an aerosol-modifying agent.

An article 30 may also comprise an aerosol generator 36, such as a heating element, that emits heat to cause the aerosol-generating material 32 to generate aerosol in use. The aerosol generator 36 may, for example, comprise combustible material, a material heatable by electrical conduction, or a susceptor. It should be noted that it is possible for the aerosol generator 36 to be part of the aerosol provision device 20 and the article 30 then may comprise the aerosol-generating material storage area 39 for the aerosol-generating material 32 such that, when the article 30 is coupled with the aerosol provision device 20, the aerosol-generating material 32 can be transferred to the aerosol generator 36 in the aerosol provision device 20. It should be appreciated that the aerosol generator 36 may encompass an aerosol generator other than a heater. More generally, an aerosol generator is an apparatus configured to cause aerosol to be generated from the aerosol-generating material. In some other embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. The aerosol-generating material 32 may, for example, be in the form of a solid, liquid or gel which may or may not contain an active substance and/or flavourants. In some embodiments, the aerosol-generating material 32 may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material 32 may for example comprise from about 50 wt %, 60 wt % or 70 wt % of amorphous solid, to about 90 wt %, 95 wt % or 100 wt % of amorphous solid.

The aerosol-generating material comprises one or more ingredients, such as one or more active substances and/or flavourants, one or more aerosol-former materials, and optionally one or more other functional materials such as pH regulators, colouring agents, preservatives, binders, fillers, stabilizers, and/or antioxidants.

The active substance as used herein may be a physiologically active material, which is a material intended to achieve or enhance a physiological response. The active substance may for example be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12. The aerosol provision device 20 includes a power source 14, such as a battery, configured to supply electrical power to the aerosol generator 36. The power source 14 in this example is rechargeable and may be of a conventional type, for example of the kind normally used in electronic cigarettes and other applications requiring provision of relatively high currents over relatively short periods. The power source 14 may be recharged through the charging port (not illustrated), which may, for example, comprise a USB connector.

The aerosol provision device 20 includes device control circuitry 28 configured to control the operation of the aerosol provision system 10 and provide conventional operating functions in line with the established techniques for controlling aerosol provision systems such as electronic cigarettes. The device control circuitry (processor circuitry) 28 may be considered to logically comprise various sub-units/circuitry elements associated with different aspects of the electronic cigarette's operation. For example, depending on the functionality provided in different implementations, the device control circuitry 28 may comprise power source control circuitry for controlling the supply of electrical power from the power source 14 to the aerosol generator 36, user programming circuitry for establishing configuration settings (e.g. user-defined power settings) in response to user input, as well as other functional units/circuitry associated functionality in accordance with the principles described herein and conventional operating aspects of electronic cigarettes. It will be appreciated the functionality of the device control circuitry 28 can be provided in various different ways, for example using one or more suitably programmed programmable computer(s) and/or one or more suitably configured application-specific integrated circuit(s)/circuitry/chip(s)/chipset(s) configured to provide the desired functionality.

The aerosol provision device 20 has an interface configured to receive the article 30, thereby facilitating the coupling between the aerosol provision device 20 and the article 30. The interface is located on a surface of the aerosol provision device 20.

The housing of the article 30 has a surface configured to be received by the interface on the aerosol provision device 20 in order to facilitate coupling between the article 30 and the aerosol provision device 20. The surface of the article may be configured to be a size and/or shape that mirrors the size and/or shape of the interface in order to facilitate coupling between the aerosol provision device 20 and the article 30. For example, the interface may comprise a cavity, chamber or other space on the surface of the aerosol provision device 20. The surface of the article 30 can then be configured to be a size and shape that mirrors the size and shape of the cavity in order for the surface of the article 30 to be inserted into the cavity.

Although not illustrated, the interface of the aerosol provision device 20 and the surface of the article 30 may have complementary features to reversibly attach and mate the article 30 to the aerosol provision device 20, such as a screw thread, bayonet fitting, latched or friction fit fixing or other fastening means.

The interface also comprises one or more connectors, such as contact electrodes, connected via electrical wiring to the control circuitry 28 and the power source 14. The article 30 also comprises one or more connectors, such as contact electrodes, connected via electrical wiring to the aerosol generator 36. In use, the article 30 is received by the interface of the aerosol provision device 20, thereby coupling the aerosol provision device 20 and the article 30. This results in the connectors on the article 30 mating with the connectors on the aerosol provision device 20, thereby allowing electrical power and electrical current to be supplied from the power source 14 of the aerosol provision device 20 to the aerosol generator 36 of the article 30.

The housing of the article 30 has a surface configured to engage with an interface on the aerosol provision device 20 in order to facilitate coupling between the article 30 and the aerosol provision device 20. In other words, the aerosol provision device 20 is configured to receive the article 30, via the interface, and the surface of the article is proximate to the interface on the aerosol provision device 20 when the article 20 is received by the interface.

The aerosol provision system 10 includes one or more air inlets 21, located on one or more of the aerosol provision device 20 and the article 30. In use, as a user inhales on the mouthpiece 35, air is drawn into the aerosol provision system 10 through the air inlets 21 and along an air channel 23 to the aerosol generator 36, where the air mixes with the vaporised aerosol-generating material 32 and forms a condensation aerosol. The air drawn through the aerosol generator 36 continues along the air channel 23 to a mouthpiece 35, carrying some of the aerosol with it, and out through the mouthpiece 35 for inhalation by the user.

By way of a concrete example, the article 30 comprises a housing (formed, e.g., from a plastics material), an aerosol-generating material storage area 39 formed within the housing for containing the aerosol-generating material 32 (which in this example may be a liquid which may or may not contain nicotine), an aerosol-generating material transfer component 37 (which in this example is a wick formed of e.g., glass or cotton fibres, or a ceramic material configured to transport the liquid from the reservoir using capillary action), an aerosol-generating area containing the aerosol generator 36, and a mouthpiece 35. Although not shown, a filter and/or aerosol modifying agent (such as a flavour imparting material) may be located in, or in proximity to, the mouthpiece 35. The aerosol generator 36 of this example comprises a heater element formed from an electrically resistive material (such as NiCr8020) spirally wrapped around the aerosol-generating material transfer component 37, and located in an air channel 23. The area around the heating element and wick combination is the aerosol-generating area of the article 30.

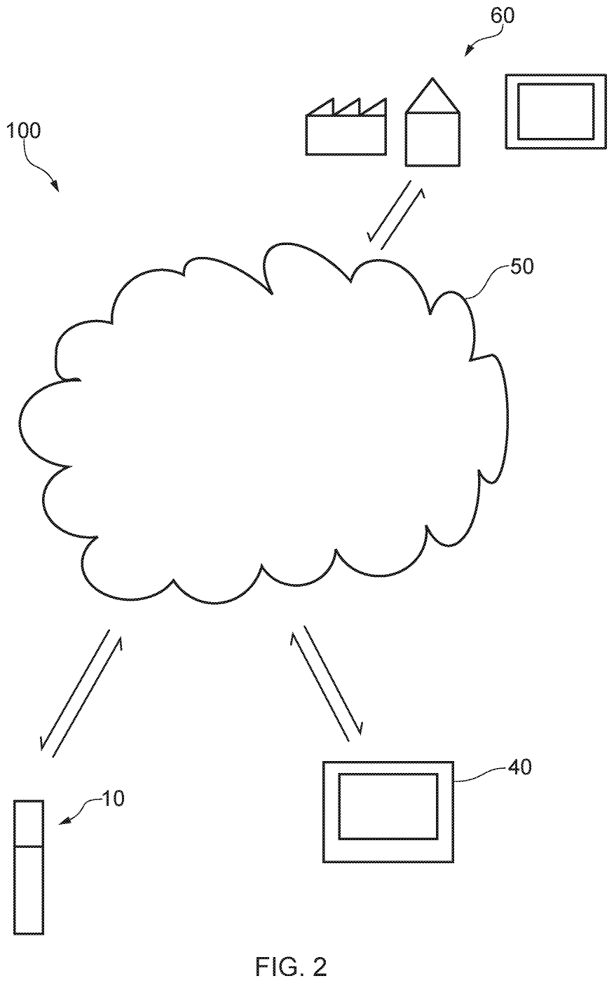

FIG. 2 is a schematic diagram of a system 100 comprising an aerosol provision system 10, where the same reference signs have been used to denote same components in FIGS. 1 and 2. System 100 comprises an aerosol provision system 10, a computing device 40, a network 50, and one or more vendors 60. Computing device 40 can be a device associated with the aerosol provision system 10, for example a mobile device, handheld computing device, or other electronic device. Computing device 40 is configured to communicate with the aerosol provision system 10 via the network 50. For example, computing device 40 can comprise a communications interface configured to communicate with the device control circuitry 28 of the aerosol provision device 20 via the network. The computing device 40 and the aerosol provision system 10 can communicate using a suitable wireless communications protocol such as Wi-Fi, Bluetooth, RFID, NFC.

The computer device 40 may be associated with a user of the aerosol provision system 10 such that the aerosol provision system 10 and the computer device 40 may be associated with one another, for example via a user profile of the user of aerosol provision system 10.

System 100 also comprises one or more vendors 60. The vendors 60 are outlets that stock or sell articles 30 for the aerosol provision system 10. For example, the vendors could be shops, wholesalers, warehouses, or online retailers or marketplaces. Computing device 40 is configured to communicate with the one or more vendors 60 via the network 50. As described above in relation to communications between the computing device 40 and the aerosol provision system 10, the computer device 40 and the one or more vendors 60 can communicate using a suitable wireless communications protocol such as Wi-Fi, Bluetooth, RFID or NFC. The wireless communications protocol used by the computing device 40 and the aerosol provision system 10 to communicate may be different to the communications protocol used by the computing device 40 and the one or more vendors 60 to communicate. For example, the computing device 40 and the aerosol provision system 10 may communicate using Bluetooth, whilst the computing device 40 and the one or more vendors 60 may communicate using Wi-Fi. Equally, the computing device 40 may use a different wireless communication protocol to communicate with different vendors 60. For example, the computer device 40 may use Wi-Fi to communicate with one vendor 60, whilst using Bluetooth to communicate with a second vendor 60.

In response to determining that an article 30 for the aerosol provision system 10 needs to be replaced, the computing device 40 is configured to transmit the request for stock information to the one or more vendors 60 of articles 30 for the aerosol provision system 10.

The computing device 40 can be configured to determine that an article 30 for aerosol provision system 10 needs to be replaced based on an indication received from the aerosol provision system 10. For example, the device control circuitry 28 can send an indication related to the article 30 to the computing device 40, and the computing device 40 is configured to determine that the article 30 needs to be replaced based on the received indication. For example, the indication can comprise an indication of the amount of aerosol generating material contained within the article 30, and the computing device 40 is configured to determine that the article 30 needs to be replaced when the amount of aerosol generating material in the article 30 is zero or less than a predetermined amount, for example 1, 5 or 10% of the capacity of the article 30. Alternatively, the indication can comprise an indication of a number of times power has been supplied to the aerosol generator 36 of the article 30 and/or a duration that power has been supplied to the aerosol generator 36 of the article 30. As it will be appreciated, the aerosol generator 36 is used each time the user inhales on the aerosol provision system 10, and the amount of aerosol generating material consumed can be calculated based on the number and duration of uses of the aerosol generator 36. The computing device 40 can then be configured to use this information to determine that the article 30 needs to be replaced.

The device control circuitry 28 can be configured to send the indication to the computing device 40 at a predetermined interval, such as every 5, 10, 30 minutes or hour, or the device control circuitry 28 can be configured to send the indication to the computing device 40 in response to a particular event, such as the device 20 being turned on, or the user inhaling on the aerosol provision system 10.

The determination that the article 30 for the aerosol provision system 10 needs to be replaced can be performed by the device control circuitry 28. The device control circuitry 28 is then configured to send an indication to the computing device 40 that the article 30 needs to be replaced.

The computing device 40 can also be configured to determine that the article 30 needs to be replaced based on an indication received from the user of the aerosol provision system 10. The indication may be provided on the computing device 40 or provided on the aerosol provision device 20, for example via an input means on the computing device 40, and the computing device 40 configured to determine that the article 30 needs to be replaced in response to receiving the indication. Alternatively, or in addition, the indication may be provided on the aerosol provision device 20, for example via an input means on the aerosol provision device 20. In this case, the device control circuitry 28 can be configured to send the indication to the computing device 40.

The computing device 40 can also be configured to determine that the article 30 needs to be replaced based on information about one or more previously placed orders for articles 30 for the aerosol provision system 10. For example, the computing device 40 can maintain information about previously placed orders for articles 30 in memory of the computing device 40, such as on a database. This information can then be used by computer device 40 to determine that the article 30 needs to be replaced. For example, the determination that the article 30 needs to be replaced can be based on a time between one or more previously placed orders and/or the number of articles 30 in a previously placed order. As it will be appreciated, the time between previously placed orders and the number of articles in any particular order can be used to determine a pattern of ordering by the user, and therefore used to determine when a user may wish to place another order.

In response to determining that the article 30 needs to be replaced, the computing device 40 is configured to transmit a request for stock information to the one or more vendors 60, for example via the network 50. The request for stock information can include one or more characteristics of the article 30. For example, the characteristics can be at least one of an ingredient or flavourant within the article 30, a concentration and/or an amount of the ingredient or flavourant within the article 30, a size or capacity for aerosol generating material of the article 30, a type or manufacturer of the article 30, and an identifier or serial number of the article 30. The one or more characteristics of the article 30 can be received from the aerosol provision system 10. For example, the computing device 40 can send a request to the device control circuitry 28 in response to determining that the article 30 needs to be replaced. In response to the request, the device control circuitry 28 can be configured determine the one or more characteristics of the article 30, for example by reading information stored in memory on the article 30, and send the one or more characteristics of the article 30 to the computing device 40. Alternatively, the device control circuitry 28 can be configured to determine the one or more characteristics of the article 30 and send the one or more characteristics of the article 30 to the computing device 40 in response to the article 30 being connected or otherwise coupled to the aerosol provision device 20. The computing device 40 can also be configured to determine the one or more characteristics of the article 30 based on one or more previous orders for articles 30 placed by the user using the computing device 40. The computing device 40 can be configured to use the one or more previous orders to determine one or more preferences for the user.

The request for stock information may be transmitted to one or more vendors 60 of articles 30 for the aerosol provision system 10 within a certain distance of the aerosol provision system 10 and/or the computing device 40 communicatively coupled to the aerosol provision system 10. In other words, only the vendors within the certain distance of aerosol provision system 10 and/or a computing device 40 are sent the request for stock information. The computing device 40 can be configured to determine the location of the one or more vendors 60, for example by sending a request for location information to each of the vendors 60, and then determine the distance to each vendor based on the location information received from each vendor. Alternatively, distance to each of the vendors could be determined based on a signal strength or other property of the wireless connection between the computing device 40 and each vendor 60. For example, the certain distance could correspond to the broadcast or communications range of the particular wireless protocol (e.g. Wi-Fi or Bluetooth) used for the wireless connection between the computing device 40 and each vendor 60, such that a request for stock information is sent to each vendor within the broadcast range of the computing device 40.

In response to receiving the request for stock information, the one or more vendors 60 are configured to send stock information to the computing device 40 via the network 50. Upon receiving the request for stock information, each vendor 60 of the one or more vendors can review, look up or otherwise retrieve information related to articles for aerosol provisions systems that the particular vendor 60 has in stock (i.e. in the inventory of the vendor), and send this stock information to the computing device 40. For example, a computer system or device associated with a vendor can receive the request for stock information and look up a database of the computer system associated with the vendor containing information related to articles for aerosol provision systems that the particular vendor has in stock. The vendor can determine the stock information required to be retrieved based on the request for stock information. For example, where the request for stock information includes one or more characteristics of the article that is determined to need to be replaced, the vendor can determine that only stock information related to the one or more characteristics of the article is required to be retrieved.

The stock information contains information necessary for the computing device 40 to calculate and generate an order for articles 30 of the aerosol provision system 10. For example, the stock information can comprise a number of articles in stock at the particular vendor 60 that correspond to the article 30 that needs to be replaced. For example, the number of articles in stock at the particular vendor 60 have the same type, size, and/or identifier of the article 30 that needs to be replaced. The stock information can also indicate that there are no articles in stock at the particular vendor 60 and/or there are no articles in stock at the particular vendor 60 of the same type, size, and/or identifier of the article 30 that needs to be replaced. In this case, the stock information can include a number of articles in stock at the particular vendor of one or more different types to the article that needs to be replaced. Alternatively, the stock information can comprise information related to each and every article in stock at the particular vendor 60, such that the computing device 40 can determine an alternative article in the event that the article that corresponds to the article 30 that needs to be replaced is not in stock at the particular vendor 60.

The stock information can also comprise a cost of each article in stock at the particular vendor that corresponds to the article that needs to be replaced. The cost may correspond to an item cost for a single article, and/or a cost for a pack, set or grouping of articles. The cost can include a delivery charge which can vary depending on the number of articles ordered. For example, due to postage and packaging costs, an order for a single article can be cheaper to deliver than an order for a large number of articles. The particular vendor may also have an agreement with the user of the aerosol provision system and/or the manufacturer of the articles that determines the cost of an article or a given number of articles. For example, there may be a fixed price agreement for a single article or for bulk purchases of articles, for example 5, 10, 50, or 100. The stock information can also comprise a lead time for delivering the articles in stock at the particular vendor that correspond to the article needs to be replaced. The lead time corresponds to the length of (for example a number of days) between an order for one or more articles being received by the vendor and the ordered articles being received by the user of the aerosol provision system 10. The lead time can also vary depending on the number of articles ordered. For example, an order for a single article could be dispatched quicker than an order for a large number of articles.

The stock information can also contain a location of the vendor 40. For example, the stock information can contain a postal address, GPS location, and/or a distance from the vendor to the computing device 40 which sent the request for stock information.

The stock information can also include an eco-score. The eco-score is determined based on the environmental or carbon footprint associated with one or more of manufacturing the article 30, obtaining the raw materials for an article 30, transporting or delivering the article 30 and operating the particular vendor's business. The eco-score for the article 30 can be determined by the particular vendor 60 or can be calculated by another party and provided to the particular vendor 60, for example by a manufacturer of the article 30. The eco-score can also be updated by the particular vendor 60 to account for the environmental footprint of the vendor 60 and/or an order. For example, where the stock information also contains a location of the vendor 60, the eco-score can be determined based on the location of vendor 60. It will be appreciated that as the distance between the vendor 60 and the user of the aerosol provision system 10 increases, the environmental or carbon footprint associated with shipping and fulfilling an order for replacement articles to the user will increase.

The computing device 40 is configured to receive the stock information from each of the one or more vendors 60, for example via the network 50. Based on the received stock information, the computing device 40 is configured to determine one or more orders. Each order comprises a number of articles to be purchased, a unit cost of each article to be purchased, a lead time for delivering the articles to be purchased and a vendor of the one or vendors 60.

The computing device 40 can be configured to determine an order for each of the one or more venders 60. For example, the computing device 40 can be configured to determine a proposed order for each of the one more vendors 60 based on the number of articles 30 in stock at the particular vendor 60, the unit cost of each article 30 to be purchased for the particular vendor 60 and the lead time for delivery articles 30 to be purchased from the particular vendor 60. The proposed order may be the order with the lowest cost per article (such as accounting for changes in unit cost with order size, pricing agreements and/or changes in delivery cost with order size), the shortest lead time or the order representing the best value for money over a period of time (i.e. an order for a single article will require a subsequent order in a shorter time period than an order for 10 articles, resulting in an increase in delivery costs for multiple small orders compared to a single big order).

As set out above, the received stock information can include an eco-score. In this case, each order of the one or more orders comprises the eco-score from the particular vendor. Alternatively, the computing device 40 can be configured to determine an eco-score for each vendor 60 based on the stock information received from the particular vendor 60, and include the determined eco-score in each order. The eco-score can be determined based on the location of the vendor 60. As set out above, the distance between the vendor 60 and the computing device 40 will impact the environmental footprint of the order and therefore affect the eco-score for each vendor 60.

Having determined the one or more orders, the computing device 40 is configured to provide a notification including the one or more orders to the user of the aerosol provision system 10. For example, the notification can be provided on a display screen of the computer device 40 and/or on a display screen of the aerosol provision system 10. In the latter example, the computing system 40 is configured to instruct the aerosol provision system 10, for example by communicating with the device control circuitry 28 via the network 50, to provide the notification on the display screen of the aerosol provision system 10.

The notification may contain all of the information related to each order, or a subset of the information. For example, the notification may contain a summary of each order, for example an identity of the vendor and the unit cost for each order, or the notification may simply inform the user that the one or more orders have been determined. The user can then interact with the computing device 40 or aerosol provision system 10 in order to receive all of the order information. For example, the user may be able to click, touch, hover over or otherwise interact with an indication or summary of each order in order to reveal all of the information (i.e. number of articles to be purchased, unit cost of each article to be purchased, lead time for delivering the articles to be purchased and vendor of the one or more vendors) related to that order.

As set out above, the received stock information can indicate that the article 30 corresponding to the article 30 that needs to be replaced is not in stock at one or more of the vendors 60. In response to receiving such an indication, the computing device 40 is configured to determine an alternative article 30 based on the received stock information and one or more user preferences. As set out above, where the article 30 corresponding to the article needs to be replaced is not in stock, the stock information from that particular vendor can comprise stock information related to alternative articles and/or all other articles in stock at that particular vendor. The computing device 40 can then use this stock information to determine an alternative article.

The alternative article is also determined based on one or more user preferences. As it will be appreciated, the user may have a preference for articles with one or more particular characteristics which can be determined and stored as user preferences. For example, the user preferences can comprise one or more of an ingredient or flavourant within the article, a concentration and/or an amount of the ingredient or flavourant, a size of the article, and/or a type of the article. The user preferences can be determined by the computing device 40 based on the user's usage of the aerosol provision system 10 over time. For example, the computing device 40 can be configured to receive usage information from the device control circuitry 28 which can be used to determine the one or user preferences. Alternatively, or in addition, the computing device 40 can be configured to receive a notification from the device control circuitry 28 when an article 30 is attached/connected or removed/disconnected from the aerosol provision device 30. The notification could contain information related to the article 30, such as one or more of an ingredient or flavourant within the article 30, a concentration and/or an amount of the ingredient or flavourant, a size of the article 30, and/or a type of the article 30, which the computing device 40 can use to determine one or more user preferences.

The computer device 40 can also determine the one or more user preferences based on one or more previous orders for articles 30 placed by the user using the computer device 40. For example, the user may order the same or similar types of article and/or articles 30 with the same or similar ingredients, and this information can be used by the computer device 40 to determine one or more user preferences.

In response to determining an alternative article, the computing device 40 is configured to provide an indication of the alternative article with the notification as set out above.

The computing device 40 can then be configured to receive, from the user, a selection of an order of the one more orders. The selection may be received on the computing device 40, for example via one or more input devices of the computing device 40, or on the aerosol provision system 10, for example via one or more input devices of the aerosol provision system 10. In the latter example, the selection is then sent from the aerosol provision system 10 (e.g. from the device control circuitry 28) to the computing device 40. In response to receiving the selection, the computing device 40 is configured to send the order to a vendor of the one or more vendors 60 to furnish the order. In other words, the computing device 40 reviews the order the user has selected in order to determine the vendor 60 that order relates to, and is then configured to send the order to that particular vendor, for example via the network 50.

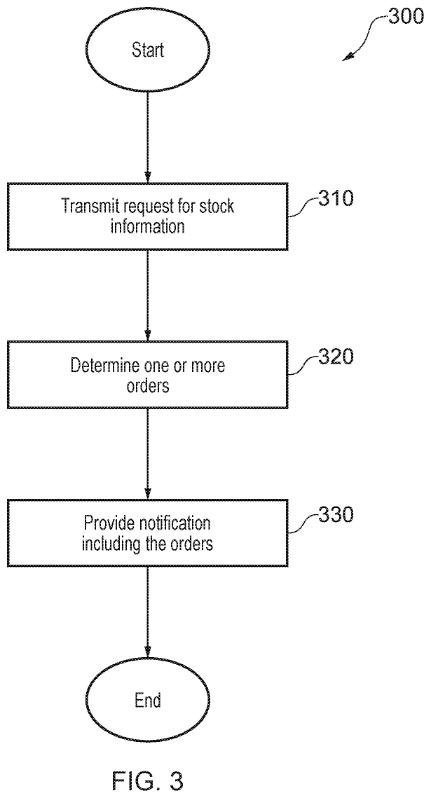

FIG. 3 is a flow diagram of a method 300 for determining one or more orders. The method begins at step 310, where a request for stock information is transmitted to one or more vendors 60 of articles for an aerosol provision system 10 in response to determining that an article 30 for the aerosol provision system needs to be replaced. At step 320, one of more orders are determined based on the stock information received from the one or more vendors 60. Each order of the one or more orders comprises a number of articles to be purchased, a unit cost of each article to be purchased, a lead time for delivering the articles to be purchased and a vendor of the one or more vendors. At step 330, a notification is provided to a user of the aerosol provision system 10 including the one or more orders. The method then ends.

The method 300 illustrated in FIG. 3 may be stored as instructions on a computer readable storage medium, such that when the instructions are executed by a processor, the method described above is performed. The computer readable storage medium may be non-transitory. In other words, the method 300 illustrated in FIG. 3 may be computer implemented. The method 300 may be performed by aerosol provision device or a related device (e.g. smart phone), such as the computing device 40.

As described above, the present disclosure relates to (but it not limited to) a computer implemented method comprising transmitting a request for stock information to one or more vendors of articles for an aerosol provision system in response to determining that an article for the aerosol provision system needs to be replaced, determining, based on the stock information received from the one or more vendors, one or more orders, wherein each order of the one or more orders comprises a number of articles to be purchased, a unit cost of each article to be purchased, a lead time for delivering the articles to be purchased and a vendor of the one or more vendors, and providing, to a user of the aerosol provision system, a notification including the one or more orders.

Thus, there has been described a computer implemented method and a computing device.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A computer implemented method comprising:
in response to determining that an article for an aerosol provision system needs to be replaced, transmitting a request for stock information to one or more vendors of articles for the aerosol provision system;
determining, based on the stock information received from the one or more vendors, one or more orders, wherein each order of the one or more orders comprises a number of articles to be purchased, a unit cost of each article to be purchased, a lead time for delivering the articles to be purchased and a vendor of the one or more vendors; and
providing, to a user of the aerosol provision system, a notification including the one or more orders.

2. The method of claim 1, wherein the stock information comprises one or more of a number of articles in stock that correspond to the article that needs to be replaced, a cost of each article in stock that corresponds to the article that needs to be replaced, and a lead time for delivering the articles in stock that correspond to the article that needs to be replaced.

3. The method of claim 1, wherein the stock information further comprises a location of the vendor, and the one or more orders are determined based on the location of the vendor.

4. The method of claim 1, wherein transmitting the request for stock information to the one or more vendors of articles for the aerosol provision system includes transmitting the request for stock information to the one or more vendors of articles for the aerosol provision system within a certain distance of the aerosol provision system and/or a computing device communicatively coupled to the aerosol provision system.

5. The method of claim 1, wherein the request for stock information includes one or more characteristics of the article that is determined to need to be replaced.

6. The method of claim 5, wherein the characteristics are at least one of an ingredient or flavourant within the article, a concentration and/or an amount of the ingredient or flavourant, a size of the article, a type of the article, and an identifier of the article.

7. The method of claim 5, wherein the characteristics are received from the aerosol provision system.

8. The method of claim 1, further comprising:
determining, in response to the stock information indicating that the article is not in stock at one or more of the vendors, an alternative article based on the received stock information and one or more user preferences; and
providing an indication of the alternative article with the notification.

9. The method of claim 1, wherein each order of the one or more orders comprises an eco-score based on the environmental footprint of the order.

10. The method of claim 9, wherein the eco-score is included in the received stock information.

11. The method of claim 9, wherein the stock information further comprises a location of the vendor, and the eco-score is determined based on the location of the vendor.

12. The method of claim 1, further comprising:
receiving, from the user, a selection of an order of the one or more orders; and
sending the order to a vendor of the one or more vendors to furnish the order.

13. The method of claim 1, wherein determining that the article needs to be replaced is based on an indication received from the aerosol provision system.

14. The method of claim 1, wherein determining that the article needs to be replaced is based on an indication received from the user.

15. The method of claim 1, wherein determining that the article needs to be replaced is based on one or more of a time between one or more previously placed orders and the number of articles in a previously placed order.

16. A non-transitory computer readable storage medium comprising instructions which, when executed, perform a method comprising:
in response to determining that an article for an aerosol provision system needs to be replaced, transmitting a request for stock information to one or more vendors of articles for the aerosol provision system;
determining, based the stock information received from the one or more vendors, one or more orders, wherein each order of the one or more orders comprises a number of articles to be purchased, a unit cost of each article to be purchased, a lead time for delivering the articles to be purchased and a vendor of the one or more vendors; and
providing, to a user of the aerosol provision system, a notification including the one or more orders.

17. A computing device comprising:
one or more processors; and
memory configured to store instruction that, when executed by the one or more processors cause the one or more processors to perform a method comprising:
in response to determining that an article for an aerosol provision system needs to be replaced, transmitting a request for stock information to one or more vendors of articles for the aerosol provision system;
determining, based the stock information received from the one or more vendors, one or more orders, wherein each order of the one or more orders comprises a number of articles to be purchased, a unit cost of each article to be purchased, a lead time for delivering the articles to be purchased and a vendor of the one or more vendors; and
providing, to a user of the aerosol provision system, a notification including the one or more orders.
